(19) United States
(12) Patent Application Publication
(10) Pub. No.: US 2001/0006905 A1
(43) Pub. Date: Jul. 5, 2001

(54) Hands-free cellular telephone base with privacy switch unit for switching between privacy and broadcast modes

(76) Inventor: Chu-Chai Hong, Hsin-Tien City (TW)

Correspondence Address: WILDMAN, HARROLD, ALLEN & DIXON, 225 West Wacker Drive, Chicago, IL, 60606-1229, US

(21) Appl. No.: 09/751,201

(22) Filed: Dec. 29, 2000

(30) Foreign Application Priority Data
Jan. 4, 2000 (TW) 089200075

(51) Int. Cl. H04B 1/16

(52) U.S. Cl. 455/569; 455/90; 455/340

(57) ABSTRACT

A hands-free cellular telephone base includes a privacy switch unit having a contact switch and a spring-biased switch actuator. The contact switch is mounted in a housing and is operable to control operation of a control circuit unit between a privacy mode and a broadcast mode. The switch actuator is mounted movably on the housing and is movable from a normal position, where the switch actuator does not actuate the contact switch for operation in the privacy mode, and a pressed position, where the switch actuator actuates the contact switch for operation in the broadcast mode. A magnet member is disposed in the housing such that, when an earphone is disposed adjacent to the switch actuator, the magnet member will attract with the earphone, thereby forcing the switch actuator to the pressed position against biasing action of the spring.

### BACKGROUND OF THE INVENTION

1. Field of the Invention

The invention relates to a hands-free cellular telephone base with a privacy switch unit that allows easy switching between privacy and broadcast modes.

2. Description of the Related Art

It is dangerous to use a cellular telephone while driving. Hands-free cellular telephone base structures for mounting in a passenger room of a car have been proposed to solve this problem. In a conventional hands-free telephone base structure, incoming call signals from the telephone are broadcast via a loudspeaker. If the driver does not wish the contents of the telephone conversation to be overheard by other passengers in the car, he can put on an earphone unit and plug an earphone connector into an earphone jack in the base structure so as to switch from the broadcast mode to a privacy mode. Since the earphone jack is small, it is not easy to make the connection, and the plugging action may divert the driver's attention from the conditions on the road, which is very dangerous.

### SUMMARY OF THE INVENTION

Therefore, the main object of the present invention is to provide a hands-free cellular telephone base with a privacy switch unit that permits easy switching between privacy and broadcast modes.

Accordingly, a hands-free cellular telephone base of this invention includes a housing adapted for seating a cellular telephone handset thereon, a telephone connector adapted to connect electrically with the handset on the housing, a loudspeaker unit mounted in the housing, an earphone jack mounted in the housing, a control circuit unit disposed in the housing and connected electrically to the telephone connector, the loudspeaker unit and the earphone jack, and a privacy switch unit for switching between broadcast and privacy modes. The privacy switch unit includes a contact switch, a switch actuator, a biasing spring and a magnet member. The contact switch is mounted in the housing and is connected electrically to the control circuit unit. The contact switch is operable so as to control operation of the control circuit unit between the privacy mode, where incoming call signals received by the control circuit unit from the handset via the telephone connector are routed by the control circuit unit to the earphone jack, and the broadcast mode, where the incoming call signals are routed by the control circuit unit to the loudspeaker unit. The switch actuator is made of a material that is non-magnetically attractive and that is magnetically permeable. The switch actuator is mounted movably on the housing and is movable along an axis from a normal position, where the switch actuator does not actuate the contact switch for operating the control circuit unit in the privacy mode, and a pressed position, where the switch actuator actuates the contact switch for operating the control circuit unit in the broadcast mode. The biasing spring is disposed to bias the switch actuator to the normal position. The magnet member is disposed in the housing and is aligned with the switch actuator along the axis. The magnet member generates magnetic lines of force such that, when an earphone is disposed adjacent to the switch actuator along the axis, the magnet member will attract with the earphone, thereby forcing the switch actuator to the pressed position against biasing action of the spring.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of the preferred embodiment of a hands-free telephone base with a privacy switch unit according to the invention;

FIG. 2 is a schematic view of the preferred embodiment in an assembled state;

FIG. 3 is a schematic sectional view of the preferred embodiment taken along line III-III of FIG. 2;

FIG. 4 is a schematic sectional view of the preferred embodiment taken along line IV-IV of FIG. 2; and

FIG. 5 is a schematic view of a modified embodiment of a hands-free telephone base with a privacy switch unit according to the invention.

### DETAILED DESCRIPTION OF THE PREFERRED EMBODIMENT

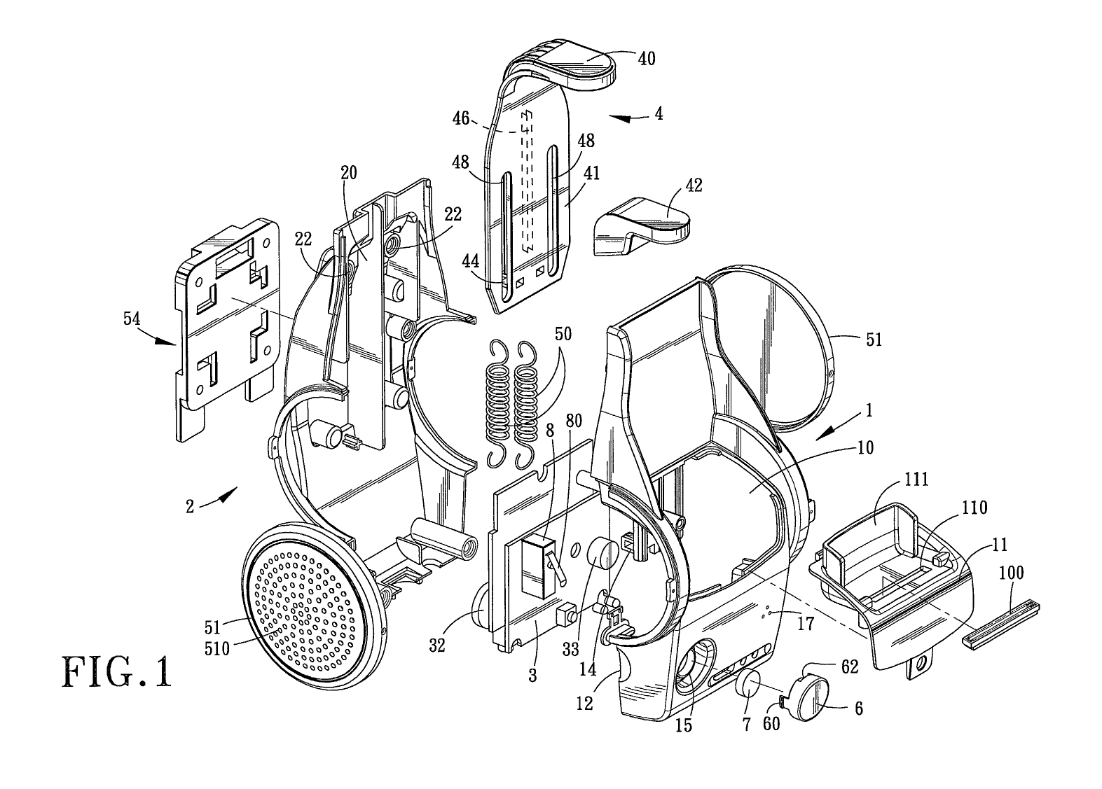

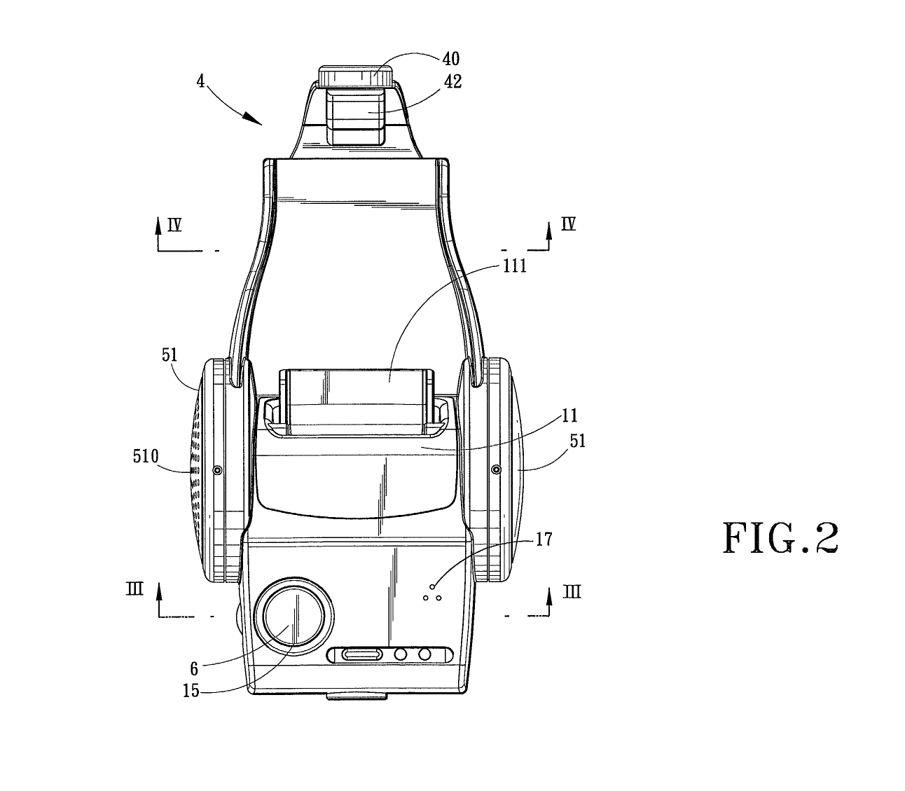

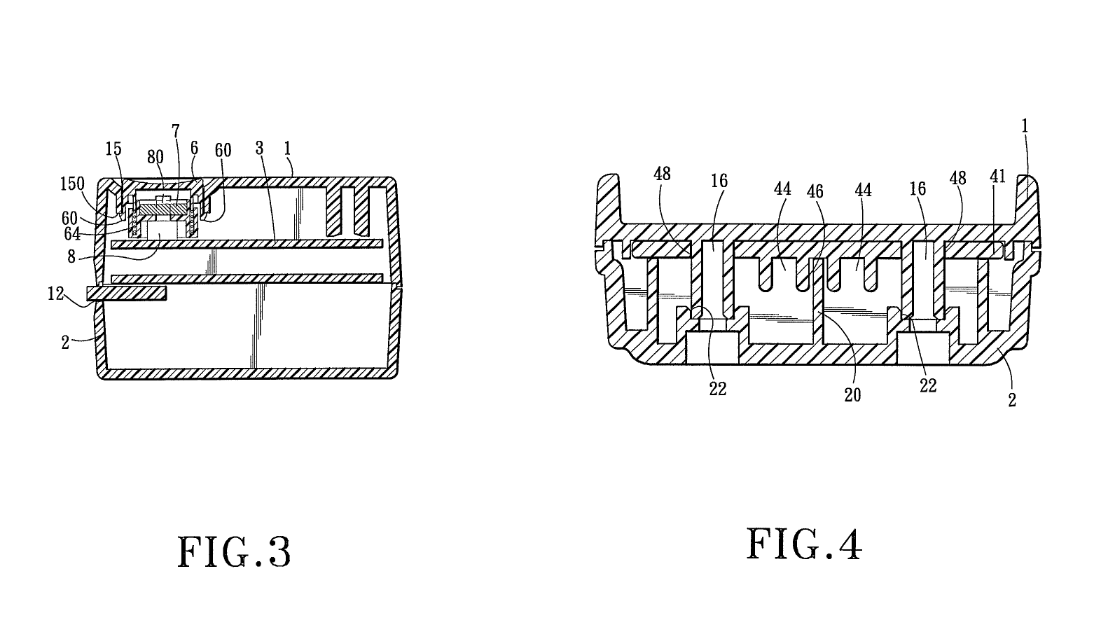

Referring to FIGS. 1 to 3, the preferred embodiment of a hands-free cellular telephone base according to the present invention is shown to include a housing unit, a telephone connector 100, a loudspeaker unit 32, an earphone jack 12, a control circuit unit 3, and a privacy switch unit for switching between privacy and broadcast modes.

The housing unit is adapted for seating a cellular telephone handset (not shown) thereon, and includes front and rear housing halves 1, 2, and a handset seat 11 mounted removably on the housing unit, such as with the use of screws, so as to permit replacement of the same to suit a specific handset. The front housing half 1 has front and rear walls, and is formed with a receiving cavity 10 extending from the front wall to the rear wall such that the seat 11 is disposed in the receiving cavity 10, and a cap-mounting bore 15 disposed below the receiving cavity 10 and extending from the front wall to the rear wall. A plurality of microphone holes 17 are also formed in the front wall of the front housing half 1 below the receiving cavity 10. The seat 11 is adapted for seating of the handset and is formed with a connector port 110 for access to the telephone connector 100, and an abutting edge 111 adapted to abut against the handset. In addition, first hooking portions 14 are provided on the front housing half 1 at suitable positions. The rear housing half 2 is inter-engageable with the front housing half 1, and has front and rear wall surfaces. The front wall surface is provided with a vertically extending guide plate 20, and two post engaging holes 22 for engaging two posts 16 (see FIG. 4) extending rearwardly from the rear wall surface of the front housing half 1.

The telephone connector 100 is adapted to connect electrically with the handset on the housing unit, and is mounted in the connector port 110. The telephone connector 100 is connected by lead wires (not shown) and complementary connectors (not shown) to the control circuit unit 3. The telephone connector 100 is thus replaceable to suit different specifications of cellular telephone handsets.

The loudspeaker unit 32 is mounted on the control circuit unit 3, which is disposed in the housing unit. A microphone 33 is also mounted on the control circuit unit 3 and is substantially aligned with the microphone holes 17 in the front housing half 1.

The earphone jack 12 is mounted on the front housing half 1 and is adapted for connection with an earphone (not shown).

The control circuit unit 3 is disposed between the front and rear housing halves 1, 2, and is connected electrically to the telephone connector 100, the loudspeaker unit 32, the microphone 33, and the earphone jack 12.

The privacy switch unit includes a contact switch 8, a switch actuator 6, a biasing spring 64 and a magnet member 7. The contact switch 8 is mounted in the housing unit and is connected electrically to the control circuit unit 3. The contact switch 8 has a press arm 80, and is operable so as to control operation of the control circuit unit 3 between a privacy mode, where incoming call signals received by the control circuit unit 3 from the handset via the telephone connector 100 are routed by the control circuit unit 3 to the earphone jack 12, and a broadcast mode, where the incoming call signals are routed by the control circuit unit 3 to the loudspeaker unit 32.

The switch actuator 6 is made of a material that is non-magnetically attractive and that is magnetically permeable. The switch actuator 6 includes a cap body mounted slidably in the cap-mounting bore 15. The cap body has two claw portions 60 and an arm groove 62. The claw portions 60 are disposed to engage an inner end face 150 of a bore-defining wall of the cap-mounting bore 15, thereby preventing untimely removal of the switch activator 6. The press arm 80 of the contact switch 8 is coupled to the cap body of the switch actuator 6 in the arm groove 62.

The switch actuator 6 is mounted movably on the front housing half 1 and is movable along an axis from a normal position, where the switch actuator 6 does not actuate the contact switch 8 for operating the control circuit unit 3 in the privacy mode, and a pressed position, where the switch actuator 6 actuates the contact switch 8 for operating the control circuit unit 3 in the broadcast mode.

The biasing spring 64 is disposed between the switch actuator 6 and the front housing half 1 to bias the switch actuator 6 to the normal position.

The magnet member 7 is disposed in a rear end of the cap-mounting bore 15 in the front housing half 1, and is aligned with the switch actuator 6 along the axis. The magnet member 7 generates magnetic lines of force such that, when the earphone (not shown) is disposed adjacent to the switch actuator 6 along the axis, the magnet member 7 will attract with the earphone, and the earphone will be drawn magnetically to the surface of the switch actuator 6. The pressure of the earphone on the switch actuator 6 causes the switch actuator 6 to displace rearwardly within the cap-mounting bore 15 so that the switch actuator 6 urges against the press arm 80 of the contact switch 8, thereby forcing the switch actuator 6 to the pressed position against biasing action of the spring 64. To switch from the broadcast mode to the privacy mode, the earphone is detached from the switch actuator 6 so that the switch actuator 6 is relieved of the pressure exerted thereon, and is once again biased by the biasing spring 64 to return to the normal position.

The telephone base of this invention further comprises a spring-loaded press unit 4 mounted between the front and rear housing halves 1, 2 and adapted to apply a downward pushing force on a top end of the handset seated on the handset seat 11. The press unit 4 includes a press plate and a spring unit 50. The press plate has a vertical slide portion 41 that engages slidably the housing unit, and a horizontal press portion 40 that extends forwardly from a top end of the vertical slide portion 41 and that is adapted to press against the top end of the handset. The horizontal press portion 40 is provided with a replaceable packing piece 42 with a shape adapted to match an upper edge of the handset. A rear wall surface of the vertical slide portion 41 is provided with two second hooking portions 44 and a guide recess 46 that corresponds to the guide plate 20 of the rear housing half 2. Two slots 48 are formed in the vertical slide portion 41 on both sides of the guide recess 46, respectively, for passage of the posts 16. The spring unit 50 is adapted to bias the vertical slide portion 41 downwardly, and includes two coil springs, each of which has one end engaging one of the first hooking portions 14, and an opposite end engaging one of the second hooking portions 44.

Furthermore, a pair of fastening elements 51 may be provided on opposite sides of the housing unit between the front and rear housing halves 1, 2 so as to enhance the connection between the front and rear housing halves 1, 2. One of the fastening elements 51 that is adjacent to the loudspeaker unit 32 is formed with a multiplicity of sound holes 510.

The telephone base may further include a removable bracket 54 mounted to a rear wall surface of the rear housing half 2 and adapted to be installed in a passenger room of a car in a known manner, such as by threaded engagement, hook-and-loop fasteners, adhesives, etc.

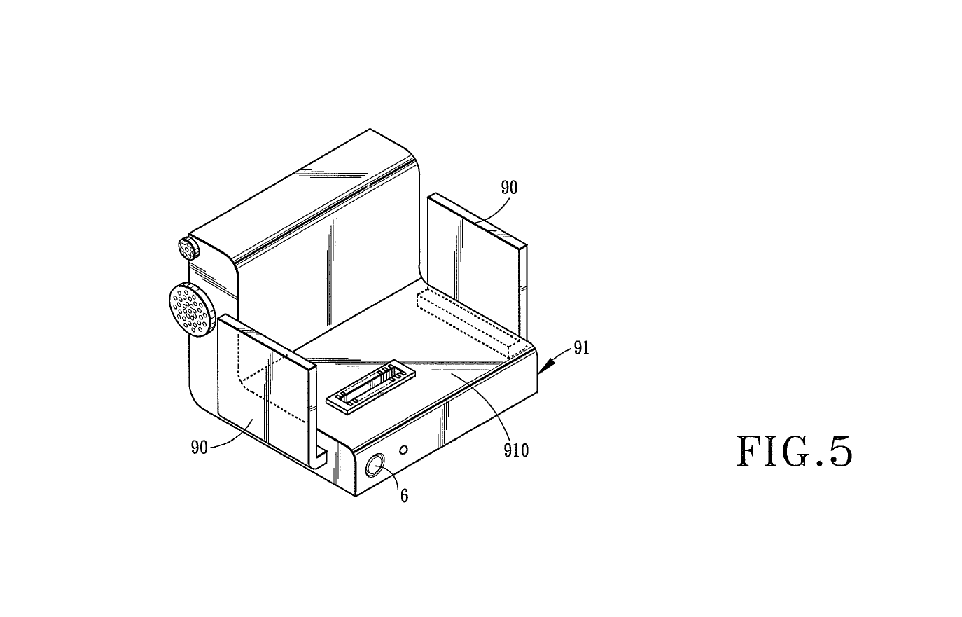

The privacy switch unit of this invention may also be adapted for use in a hands-free cellular telephone base of a different structure as shown in FIG. 5. In this example, the privacy switch unit is disposed in a housing 91. The housing 91 includes a pair of elastic clamping elements 90 adapted for clamping a handset disposed on a receiving face 910 thereof. When an earphone (not shown) is disposed adjacent to a switch actuator 6, the privacy switch unit is in a broadcast mode, and the sound is broadcast via a loudspeaker unit (not visible). To switch to the privacy mode, the earphone is removed from the switch actuator 6.

Thus, it can be appreciated that the present invention provides a convenient and simple way of switching between broadcast and privacy modes.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A hands-free cellular telephone base, comprising:
a housing adapted for seating a cellular telephone handset thereon;
a telephone connector adapted to connect electrically with the handset on said housing;
a loudspeaker unit mounted in said housing;
an earphone jack mounted on said housing;
a control circuit unit disposed in said housing and connected electrically to said telephone connector, said loudspeaker unit and said earphone jack; and
a privacy switch unit including
a contact switch mounted in said housing and connected electrically to said control circuit unit, said contact switch being operable so as to control operation of said control circuit unit between a privacy mode, where incoming call signals received by said control circuit unit from the handset via said telephone connector are routed by said control circuit unit to said earphone jack, and a broadcast mode, where the incoming call signals are routed by said control circuit unit to said loudspeaker unit,
a switch actuator made of a material that is non-magnetically attractive and that is magnetically permeable, said switch actuator being mounted movably on said housing and being movable along an axis from a normal position, where said switch actuator does not actuate said contact switch for operating said control circuit unit in the privacy mode, and a pressed position, where said switch actuator actuates said contact switch for operating said control circuit unit in the broadcast mode,
a biasing spring for biasing said switch actuator to the normal position, and
a magnet member disposed in said housing and aligned with said switch actuator along the axis, said magnet member generating magnetic lines of force such that, when an earphone is disposed adjacent to said switch actuator along the axis, said magnet member will attract with the earphone, thereby forcing said switch actuator to the pressed position against biasing action of said spring.

2. The hands-free cellular telephone base of claim 1, wherein said housing is formed with a cap-mounting bore, said switch actuator including a cap body mounted slidably in said cap-mounting bore.

3. The hands-free cellular telephone base of claim 2, wherein said contact switch has a press arm coupled to said cap body of said switch actuator.

4. The hands-free cellular telephone base of claim 1, wherein said housing has a handset seat mounted removably thereon and adapted for seating of the handset, said seat being formed with a connector port for mounting of said telephone connector therein.

5. The hands-free cellular telephone base of claim 1, further comprising a spring-loaded press unit mounted on said housing and adapted to apply a downward pushing force on a top end of the handset seated on said housing.

6. The hands-free cellular telephone base of claim 5, wherein said press unit includes:
a press plate having a vertical slide portion that engages slidably said housing, and a horizontal press portion that extends forwardly from a top end of said vertical slide portion and that is adapted to press against the top end of the handset; and
a spring unit for biasing said vertical slide portion downwardly.

7. A privacy switch unit for a hands-free cellular telephone base that includes a housing for seating a cellular telephone handset thereon, a telephone connector for connecting electrically with the handset on the housing, a loudspeaker unit mounted in the housing, an earphone jack mounted on the housing, and a control circuit unit disposed in the housing and connected electrically to the telephone connector, the loudspeaker unit and the earphone jack, said privacy switch unit comprising:
a contact switch adapted to be mounted in the housing and to be connected electrically to the control circuit unit, said contact switch being operable so as to be adapted to control operation of the control circuit unit between a privacy mode, where incoming call signals received by the control circuit unit from the handset via the telephone connector are routed by the control circuit unit to the earphone jack, and a broadcast mode, where the incoming call signals are routed by the control circuit unit to the loudspeaker unit;
a switch actuator made of a material that is non-magnetically attractive and that is magnetically permeable, said switch actuator being adapted to be mounted movably on the housing and being movable along an axis from a normal position, where said switch actuator does not actuate said contact switch for operating the control circuit unit in the privacy mode, and a pressed position, where said switch actuator actuates said contact switch for operating the control circuit unit in the broadcast mode;
a biasing spring for biasing said switch actuator to the normal position; and
a magnet member adapted to be disposed in the housing and aligned with said switch actuator along the axis, said magnet member generating magnetic lines of force such that, when an earphone is disposed adjacent to said switch actuator along the axis, said magnet member will attract with the earphone, thereby forcing said switch actuator to the pressed position against biasing action of said spring.

8. The privacy switch unit of claim 7, wherein said switch actuator includes a cap body that is adapted to be mounted slidably in a cap-mounting bore formed in the housing.

9. The privacy switch unit of claim 8, wherein said contact switch has a press arm coupled to said cap body of said switch actuator.
